(19) United States
(12) Patent Application Publication
(10) Pub. No.: US 2015/0198507 A1
(43) Pub. Date: Jul. 16, 2015

(54) Increased Pressure for Emergency Steering Pump Startup Test

(71) Applicant: Caterpillar Inc., Peoria, IL (US)

(72) Inventors: David Arthur Mork, Yorkville, IL (US); Biagio Ciarla, Appleton, WI (US); Wendell Dean Stahl, Bradford, IL (US); Daniel Todd Mather, Lockport, IL (US)

(73) Assignee: Caterpillar, Inc., Peoria, IL (US)

(21) Appl. No.: 14/156,136

(22) Filed: Jan. 15, 2014

(51) Int. Cl. G01M 17/06; B62D 5/30

(52) U.S. Cl. CPC G01M 17/06; B62D 5/30

(57) ABSTRACT

A method of determining readiness of an emergency steering pump system is provided. The method may include the steps of detecting a startup condition; determining a standby pressure provided by a primary pump and a margin pressure to be provided by a secondary pump; engaging the secondary pump for a predefined duration based on the standby pressure and the margin pressure; and determining readiness based on a cumulative pressure of the standby pressure and the margin pressure as compared to a predefined threshold corresponding to load demand.

### TECHNICAL FIELD

The present disclosure relates generally to steering pump assemblies, and more particularly, to systems and methods for determining operational readiness of emergency steering pump systems.

### BACKGROUND

Steering pumps are commonly used in the relevant art to, for instance, facilitate a machine operator's ability to steer, maneuver or otherwise control vehicles, work machines, and the like. As a safety feature, some machines are integrated with emergency steering mechanisms which provide an alternative or a secondary power source designed to supply backup power to the steering pump in emergency situations. Such emergency steering systems enable the operator to maintain control of the machine or vehicle in the event of a failure in the primary power source, such as due to leakage, a pump malfunction, or the like.

Emergency steering mechanisms are also further implemented with an operational readiness test or feature that is automatically performed at machine startup to ensure proper functionality of the emergency system. In a typical operational readiness test, the emergency steering pump is briefly activated to determine if the resulting pressure supplied by the secondary energy source is sufficient to take over the steering system if necessary. Correspondingly, the typical emergency steering mechanism requires means to rapidly accumulate pressure within a relatively short period of time.

Conventional systems with electrically driven emergency steering mechanisms rely on steering pumps with a fixed pressure relief valve adapted to provide rapid pressure accumulation that is sufficient for not only the operational readiness tests at startup but also for actual emergency conditions. However, such systems accumulate pressure irrespective to the overall system or demands thereof and force the emergency pump to operate at maximum relief. Due to the high levels of pressure involved and the time required to reach threshold pressures, these assemblies are prone to premature failure such as overheating conditions in the electric motor and/or associated motor relays.

Also used in the art are unloader-type steering pumps which allow the emergency pump to build pressure based on system demand, and thereby reduce premature failures commonly associated with pumps using fixed pressure relief valves. Unloader-type steering pumps provide some advantages, but unlike an emergency pump using a fixed relief valve, an unloader-type emergency steering pump alone may not provide the output pressure needed for differentiation over the primary pump standby pressure required to satisfy the operational readiness test.

The present disclosure is directed at addressing one or more of the deficiencies set forth above. However, it should be appreciated that the solution of any particular problem is not a limitation on the scope of this disclosure or of the attached claims except to the extent express noted. Additionally, the inclusion of any problem or solution in this Background section is not an indication that the problem or solution represents known prior art except as otherwise expressly noted.

### SUMMARY OF THE DISCLOSURE

In one aspect of the present disclosure, a method of determining readiness of an emergency steering pump system is provided. The method may include the steps of detecting a startup condition; determining a standby pressure provided by a primary pump and a margin pressure to be provided by a secondary pump; engaging the secondary pump for a predefined duration based on the standby pressure and the margin pressure; and determining readiness based on a cumulative pressure of the standby pressure and the margin pressure as compared to a predefined threshold corresponding to load demand.

In another aspect of the present disclosure, an emergency steering pump system is provided for a primary pump providing a standby pressure. The emergency steering pump system may include a secondary pump for providing a margin pressure, a pressure control mechanism in communication with at least one of the primary pump and the secondary pump, and a controller in communication with each of the primary pump and the secondary pump. The resolver may be configured to accumulate the margin pressure based at least partially on load demand. The controller, upon startup, may be configured to engage the secondary pump for a predefined duration, monitor a cumulative pressure of the standby pressure and the margin pressure, and determine readiness of the secondary pump based on the cumulative pressure as compared to a predefined threshold corresponding to the load demand.

In yet another aspect of the present disclosure, an emergency steering pump system is provided for a primary pump providing at least standby pressure upon startup. The emergency steering pump system may include a secondary pump for providing a margin pressure, and a resolver in communication with each of the primary pump and the secondary pump. The resolver may be configured to accumulate the margin pressure provided by the secondary pump such that a sum of the standby pressure and the margin pressure substantially approximates load demand.

### BRIEF DESCRIPTION OF THE DRAWINGS

FIG. 1 is a diagrammatic view of one embodiment of a work machine having an emergency steering pump system of the present disclosure incorporated therewith;

FIG. 2 is a schematic view of one embodiment of a steering system for a work machine having an emergency steering pump system of the present disclosure incorporated therewith;

FIG. 3 is a schematic view of another embodiment of a steering system for a work machine having an emergency steering pump system;

FIG. 4 is a schematic view of yet another embodiment of a steering system for a work machine having an emergency steering pump system;

FIG. 5 is a diagrammatic view of one embodiment of an algorithm or method of determining the operational readiness of the emergency steering pump systems of FIGS. 2 and 3; and

FIG. 6 is a diagrammatic view of another embodiment of an algorithm or method of determining the operational readiness of the emergency steering pump system of FIG. 4.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

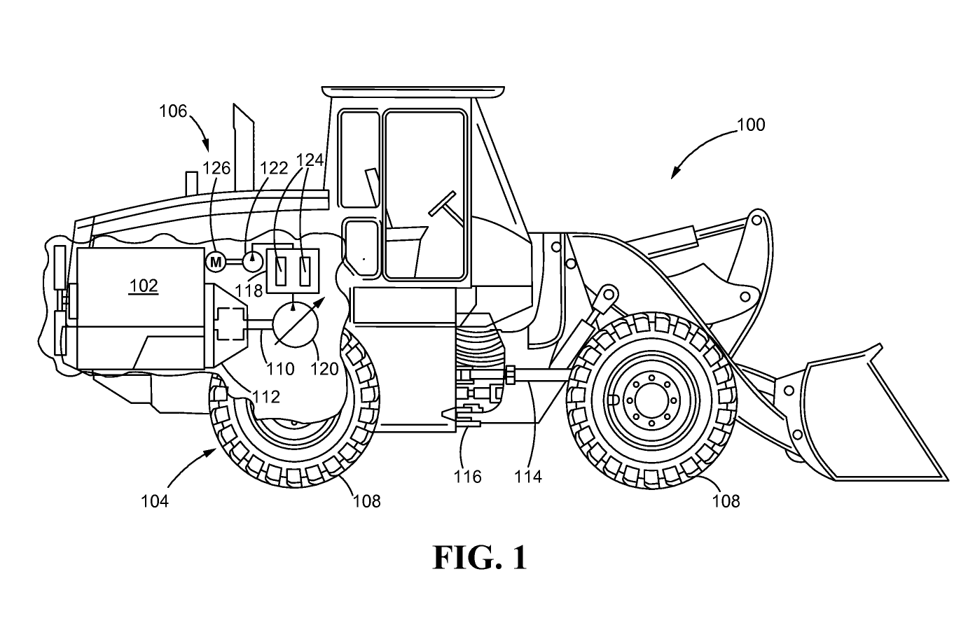

Referring to FIG. 1, one embodiment of a work machine 100 is provided according to one embodiment of the present disclosure. As shown in FIG. 1, the work machine 100 may generally include, among other things, a power source 102, traction devices 104 and a steering system 106 for steering the traction devices 104 and the associated work machine 100. It should be understood that the work machine 100 may embody any mobile machine that performs some type of operation associated with an industry such as mining, construction, farming, or any other industry known in the art. For example, the work machine 100 may be an earthmoving machine such as a wheel loader, a dump truck, a backhoe, a motor grader, or any other suitable operation-performing machine. Moreover, the embodiments disclosed herein may be implemented in any hydromechanical machine in which an automatic and/or manual health check is to be run on an unloader-type backup pump that requires differentiation from a primary pump pressure within the same hydraulic circuit.

The power source 102 may be an engine such as, for example, a diesel engine, a gasoline engine, a gaseous fuel powered engine such as a natural gas engine, or any other engine apparent to one skilled in the art. The power source 102 may also embody another source of power such as a fuel cell, a power storage device, or any other source of power known in the art. The traction devices 104 may include wheels 108, for example, located on each side of the work machine 100. Alternatively, the traction devices 104 may include tracks, belts or other traction devices. In other embodiments, the fraction devices 104 may incorporate a differential gear assembly configured to divide power from the power source 102 between the wheels 108 located on either side of the work machine 100. For instance, the differential gear assembly may allow the wheels 108 on one side of the work machine 100 to turn faster than the wheels 108 located on an opposite side of the work machine 100.

As illustrated in FIG. 1, the steering system 106 may be coupled to the power source 102 via an input shaft 110 through a torque converter 112. Alternatively, the steering system 106 may be coupled to the power source 102 via a gear box (not shown), connected directly to the power source 102, or connected to the power source 102 in any other manner known in the art. As shown, one or more steering cylinders 114 may also be located on each side of the work machine 100 and configured to function in cooperation with a centrally-located articulated joint 116. To affect steering, the steering cylinder 114 located on one side of the work machine 100 may extend while the steering cylinder 114 located on the opposite side of the work machine 100 simultaneously refracts, thereby causing a forward end of the work machine 100 to pivot about the articulated joint 116 relative to a back end of the work machine 100. It should be noted that the number of the steering cylinders 114, as well as the configuration and connection of the steering cylinders 114 in the work machine 100 may vary.

The extension and retraction of the steering cylinder 114 may be accomplished by creating an imbalance of force on a piston assembly (not shown) disposed within a tube of the steering cylinder 114. In one embodiment, each of the steering cylinders 114 may include a first chamber and a second chamber separated by the piston assembly. The piston assembly may include a piston axially aligned with and disposed within the tube. The piston may include two opposing hydraulic surfaces, one associated with each of the first and second chambers. The first and second chambers may be selectively supplied with a pressurized fluid and drained of the pressurized fluid to create an imbalance of force on the two surfaces that causes the piston assembly to axially move within the tube. For example, a fluid pressure within the first hydraulic chamber acting on a first hydraulic surface being greater than a fluid pressure within the second hydraulic chamber acting on a second opposing hydraulic surface may cause the piston assembly to displace to increase the effective length of steering cylinder 114. Similarly, when fluid pressure acting on the second hydraulic surface is greater than fluid pressure acting on the first hydraulic surface, the piston assembly may retract within the tube to decrease the effective length of steering cylinder 114.

Still referring to FIG. 1, the steering system 106 may include a steering control unit 118 as well as a primary source of pressurized fluid or primary pump 120. As shown, the steering system 106 may also incorporate a secondary source of pressurized fluid or secondary pump 122 that is disposed in fluid communication with the steering control unit 118. The steering control unit 118 may be in fluid communication with the steering cylinder 114 and configured to control actuation of the steering cylinder 114. In particular, the steering control unit 118 may generally include one or more steering valves 124, such as one or more solenoids actuated against spring biases, or any other directional valve mechanisms that function to meter pressurized fluid into the steering cylinder 114. In other embodiments, the steering control unit 118 may be hydraulically actuated, mechanically actuated, pneumatically actuated, or actuated in any other suitable manner. The movement of the steering control unit 118 may control the flow of the pressurized fluid into and/or out of the steering cylinders 114. It should be understood that although only one steering control unit 118 is depicted in the accompanied figures, the steering system 106 may include additional steering control units 118 to be associated with each of the steering cylinders 114.

In one embodiment, the primary pump 120 may be a fixed displacement pump, a variable displacement pump, a variable flow pump, or any other source of pressurized fluid known in the art. The primary pump 120 may be configured to provide a flow of pressurized fluid in the steering system 106. The primary pump 120 may be operatively coupled to an output of the power source 102, for example, via a countershaft, a belt, an electrical circuit, or any other suitable manner. It should be noted that the primary pump 120 may also supply the pressurized fluid to other circuits in the work machine 100. The secondary pump 122 may include a ground-driven pump, an accumulator, or an electrically-driven unloader-type pump. For example, the secondary source pump 122 may be driven by an electric motor 126 coupled thereto. The electric motor 126 may be an AC drive motor or a DC drive motor, depending on the application.

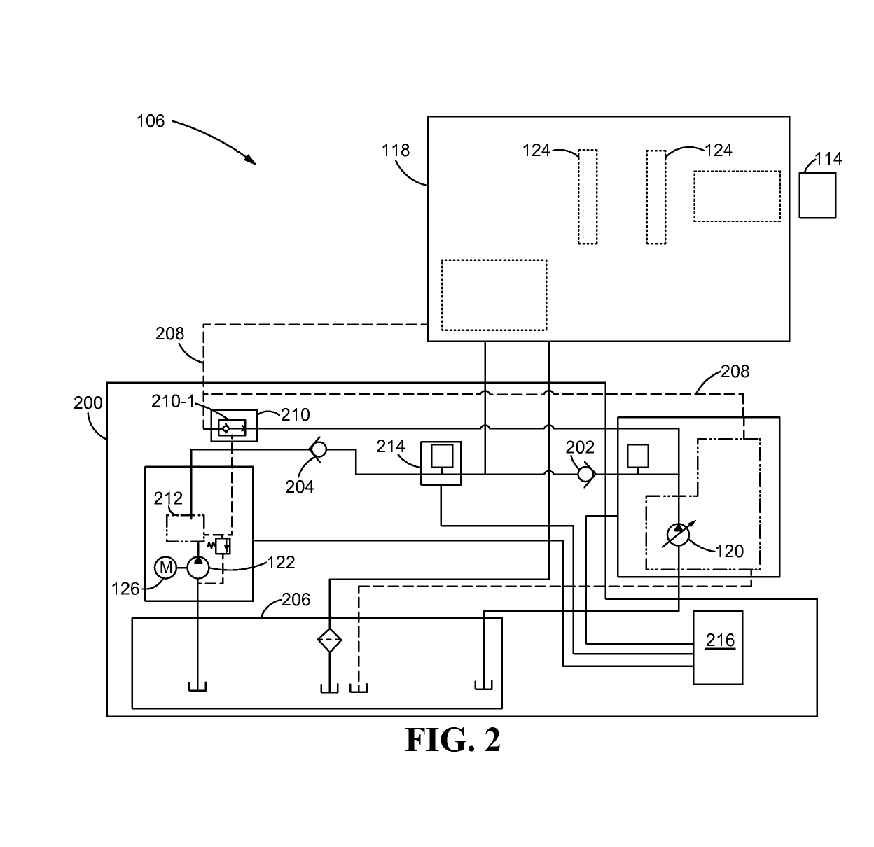

Turning to FIG. 2, one example embodiment of an emergency steering pump system 200 is provided in conjunction with a steering system 104. As shown, the emergency steering pump system 200 may generally provide or be implemented with the primary pump 120 and the secondary pump 122, both of which may be in fluid communication with the steering control unit 118. In one such embodiment, check valves 202, 204 may be disposed within fluid passageways generally between the primary pump 120 and the secondary pump 122. The check valves 202, 204 may ensure one-directional flow of the pressurized fluid towards the steering control unit 118 and prevent back-flow of the pressurized fluid from any one of the primary pump 120 and the secondary pump 122 to the other. Moreover, one or more of the steering control unit 118, the primary pump 120 and the secondary pump 122 may also communicate with a sump or tank 206 to allow drainage of the pressurized fluid in the steering system 106.

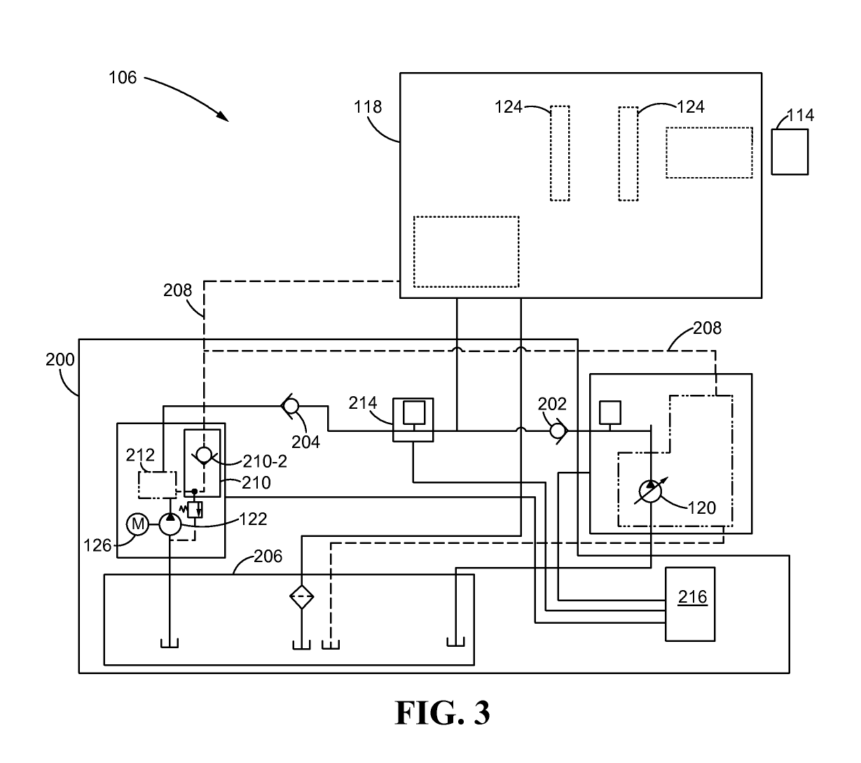

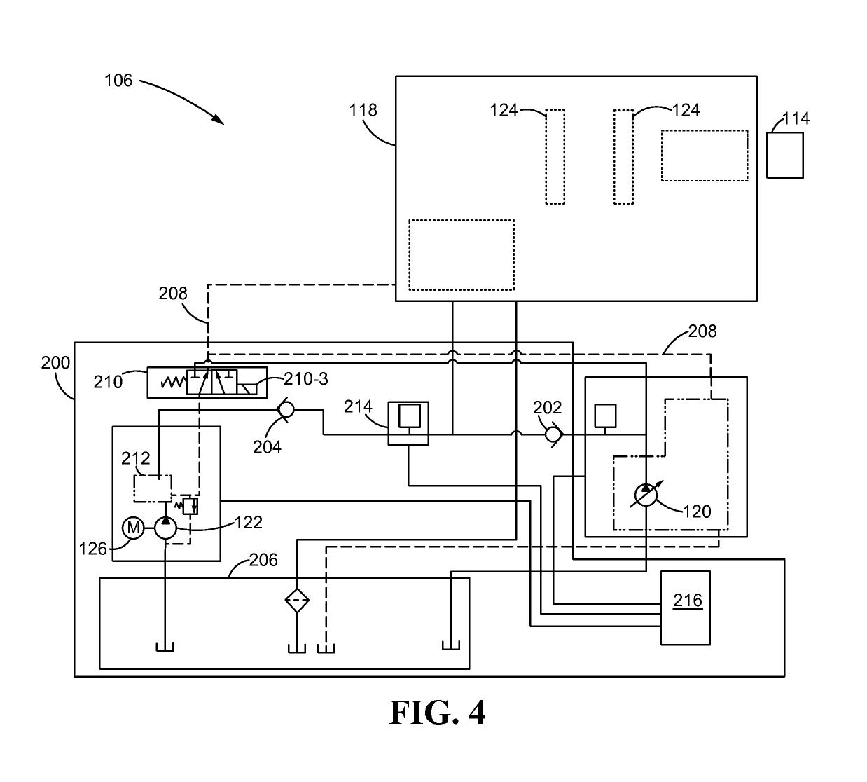

Upon startup of the work machine 100, the primary pump 120 of FIG. 2 may operate to provide a standby pressure while the secondary pump 122 may also operate to provide a margin pressure, or a pressure differential between the load demand and the standby pressure supplied by the primary pump 120. More particularly, the primary pump 120 may sense the load demand from the steering system 106 via a communication line 208, for instance, carrying a load sense signal, or the like, that is indicative of the load demand corresponding to the given steering input. The load sense signal may further be communicated to the secondary pump 122 via a pressure control mechanism 210. The secondary pump 122 may be an unloader-type pump, or provided with an actuatable unloader valve 212 configured to adjust a pressure of the secondary pump 122, or the margin pressure, based on the pressure differential as indicated, for example, via the resolver 210-1 shown in FIG. 2, or the like. In alternative embodiments, the pressure control mechanism 210 may employ a choke/check valve configuration 210-2 as shown in FIG. 3, an electrical solenoid 210-3 as shown in FIG. 4, or the like.

More specifically, in the embodiment of FIG. 2, the pressure control mechanism 210 may be configured with a resolver 210-1 such that, irrespective of the standby pressure of the primary pump 120, the secondary pump 122 enables the emergency steering pump system 200 to consistently supply a cumulative pressure approximately equal to the sum of the standby pressure from the primary pump 120 and the margin pressure from the secondary pump 122. In alternative embodiments, the pressure control mechanism 210 may employ the choke/check valve configuration 210-2 shown in FIG. 3, for instance, providing a check valve downstream of the steering control unit 118. While the emergency steering pump system 200 of FIG. 3 produces an output pressure that is not dependent on the primary standby pressure, the choke/check valve 210-2 may be configured to sufficiently boost pressure of the secondary pump 122 to approximately double the margin pressure. In still further alternatives, the pressure control mechanism 210 may employ, for instance, the 2-position, 3-way solenoid 210-3 shown in FIG. 4. Similar to the resolver 210-1 in the circuit of FIG. 2, the solenoid 210-3 of FIG. 4 may enable a substantially consistent supply of pressure approximately equal to the sum of the standby pressure from the primary pump 120 and the margin pressure from the secondary pump 122. In contrast to the resolve 210-1, however, the solenoid 210-3 may rely on one or more input signals provided thereto.

Furthermore, the emergency steering pump systems 200 of FIGS. 2-4 may also include at least one pressure sensor 214 in communication with one or more of the primary pump 120 and the secondary pump 122 that is configured to detect the sum or cumulative pressure of the standby pressure and the margin pressure, and communicate the cumulative pressure to a controller 216 associated with the work machine 100. The controller 216 may be implemented using any one or more of a processor, a microprocessor, a microcontroller, an electronic control module (ECM), an electronic control unit (ECU), or any other suitable means for performing one or more operations for determining the operational status or readiness of the secondary pump 122 and/or the emergency steering pump system 200. Numerous commercially available means can be used to perform the functions of the controller 216. The controller 216 may also perform other functions not described herein. The controller 216 may additionally include, or be able to otherwise communicate with, a memory, a secondary storage device, other controllers or components associated with the work machine 100. Moreover, depending on the application, various other circuits may be associated with the controller 216 such as power supply circuitry, signal conditioning circuitry, solenoid driver circuitry, and the like.

A person of ordinary skill in the art will appreciate that the configurations shown in the accompanied figures depict example configurations. Other arrangements or configurations of the primary pump 120 and the secondary pump 122 may be employed. It should be understood that the secondary pump 122 may be provided as a backup power source in the event that the primary pump 120 may experience a failure, such as deactivated, defected, damaged, or otherwise inoperable. As currently configured, the operational health or readiness of the secondary pump 122 and/or the overarching emergency steering pump system 200 may be determined, for example, automatically upon startup of the work machine 100, at periodic intervals, or manually upon user request, and the like. Moreover, the operational readiness tests may be initiated once the controller 216 first confirms that the power source or engine 102 is operating and the relevant steering valves 124 of the steering system 106 are closed.

In the configurations of FIGS. 2 and 3, for instance, to determine the operational readiness of the emergency steering pump system 200, the controller 216 may generally be configured to determine and/or monitor the standby pressure provided by the primary pump 120, determine and/or monitor the margin pressure provided by the secondary pump 122, and engage the secondary pump 122 for a predefined test duration upon machine startup. In the configuration of FIG. 4, for instance, the controller 216 may additionally activate the electronic solenoid 210-3 to communicate the primary standby pressure to an emergency load sense, and engage the secondary pump 122 for a predefined test duration. Furthermore, the controller 216 may determine the cumulative pressure of the standby pressure provided by the primary pump 120 and the margin pressure provided by the secondary pump 122, compare the cumulative pressure to a predefined threshold corresponding to the given load demand, and assess the operational readiness of the emergency steering pump system 200 based on the comparison.

If the cumulative pressure substantially reaches the predefined threshold, or approximates the predefined threshold within acceptable limits, upon or prior to expiration of the predefined test duration, the controller 216 may designate the emergency steering pump system 200 as operational and ready to at least temporarily support the load demand in the event of a failure in the primary pump 120. If, however, the cumulative pressure is less than or does not sufficiently approximate the predefined threshold upon expiration of the predefined test duration, the controller 216 may designate the emergency steering pump system 200 as inoperative or not ready. Furthermore, if the emergency steering pump system 200 is determined to be operational, the controller 216 may proceed to normal machine operations. Additionally or optionally, the controller 216 may signal or provide indications of the successful test, for instance, to an operator of the work machine 100 via any one or more interfaces that are disposed in relation to the work machine 100. Alternatively, if the emergency steering pump system 200 is determined to be inoperative or deficient in any manner, the controller 216 may signal or provide indications informing or warning the operator of the failed test prior to proceeding with normal machine operations.

### INDUSTRIAL APPLICABILITY

Work machines can be provided with a secondary source of pressurized fluid or secondary pump either as standard equipment or as optional attachments to meet local regulations and/or customer preferences. The secondary pump may serve as a backup steering power source in the event that the primary source of pressurized fluid or primary pump experiences failure. In the instance of using a secondary pump, such as an unloader-type pump driven by an electric motor, additional regulations may require an ability to test the functionality of the emergency steering pump system, or the combined primary pump and secondary pump, and communicate an indication of an appropriate status to the operator, based on whether certain predetermined test thresholds are achieved. The present disclosure serves to provide such features in a manner which minimizes design complexity and the overall costs of implementation and maintenance. Moreover, the present disclosure provides means to quickly and adequately accumulate and maintain pressure within an emergency steering pump system during an operational readiness test while reducing wear to the associated backup or secondary pump.

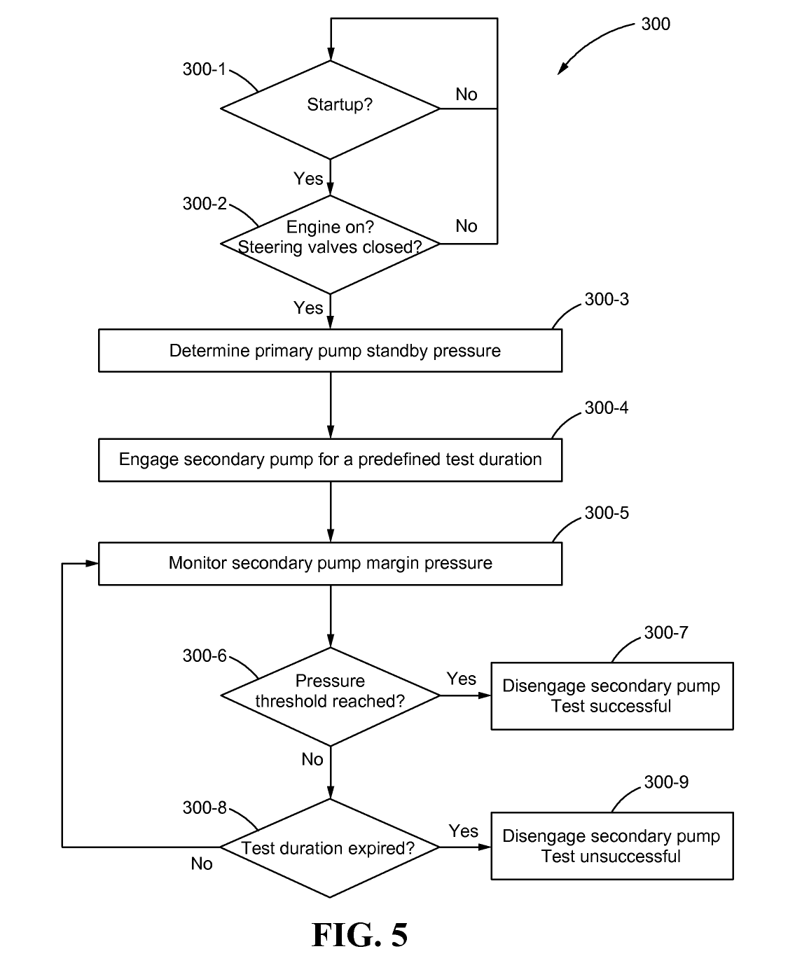

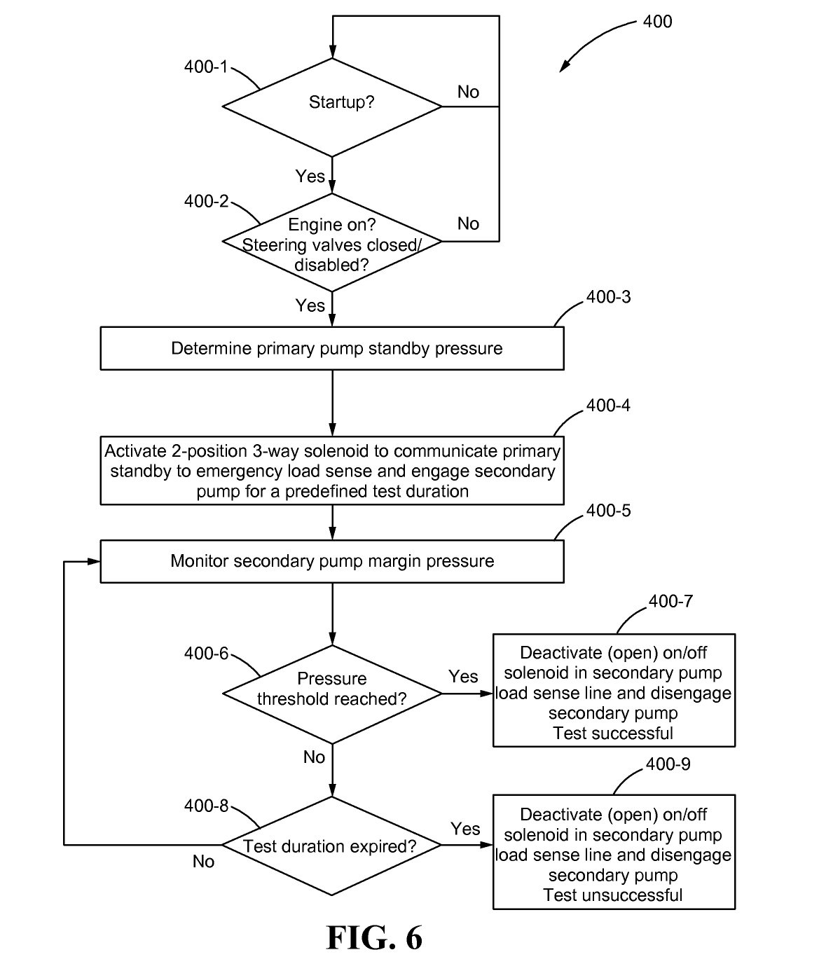

Referring now to FIGS. 5 and 6, exemplary algorithms or methods 300, 400 for operating controllers 216 associated with emergency steering pump systems 200 are diagrammatically provided. For example, the method 300 of FIG. 5 may be used to operate the emergency steering pump systems 200 of FIGS. 2 and 4 which supply output pressures that are dependent on primary standby pressure and employ a resolver 210-1 or a 2-position, 3-way solenoids 210-3, or the like. Alternatively, the method 400 of FIG. 6 may be used to operate the emergency steering pump system 200 of FIG. 3 which supplies output pressures that are not dependent on primary standby pressure and employ choke/check valve configuration 210-2, or the like.

According to the method 300 of FIG. 5, the controller 216 in step 300-1 may initially standby for a startup condition which automatically triggers a health check routine to be performed on the emergency steering pump systems 200 of FIGS. 2 and 3. In particular, the startup condition may correspond to the initial startup or engagement of the associated work machine 200, the associated power source or engine 102 of the work machine 200, or any other machine component that is operatively linked to the steering system 106. In other modifications, the controller 216 may be configured to automatically initiate the health check routine at predefined periodic intervals, in which case the controller 216 in step 300-1 may additionally or alternatively standby for the next scheduled testing period. In still further alternatives, the controller 216 in step 300-1 may standby for any manually triggered instructions to conduct a health check routine which may be performed in addition to or in place of the routine automatically performed upon startup.

Once a startup condition or an otherwise sufficient triggering event is detected, the controller 216 in step 300-2 may first ensure that all machine parameters satisfy prerequisite conditions prior to proceeding with the health check or operational readiness test. In accordance with the method 300 of FIG. 5, for example, the controller 216 may be configured to determine whether the associated power source or engine 102 is operating, and whether the relevant hydraulic valves 124 of the steering system 106 are enabled or closed. If the power source or engine 102 is determined to be off, or if all relevant steering valves 124 are not yet closed, the controller 216 may return to step 300-1 and remain in standby until all prerequisite conditions are satisfied. In alternative embodiments, the controller 216 may be configured to detect for other machine parameters during step 300-2 which may be necessary for optimum testing. In other alternatives, the controller 216 may be configured to perform step 300-2 in conjunction with the standby step of 300-1.

If all prerequisite conditions are satisfied in step 300-2, for example, if the engine 102 is confirmed to be operating and the steering valves 124 are confirmed to be closed, the controller 216 may proceed to determine or monitor the standby pressure provided by the primary pump 120 in step 300-3. The controller 216 may observe the standby pressure via any one or more pressure sensors 214 that are dedicated to or otherwise associated with the primary pump 120. In step 300-4, the controller 216 may be configured to engage the secondary pump 122 for a predefined test duration. For example, in an unloader-type secondary pump 122 that is driven by an electric motor 126, the controller 216 may engage the electric motor 126 for a duration that has been preprogrammed within the controller 216. Once the secondary pump 122 is operating, the controller 216 may monitor the margin pressure provided by the secondary pump 122 in step 300-5, in essence, by monitoring the cumulative pressure provided by the emergency steering pump system 200. In particular, the controller 216 may be configured to obtain the cumulative pressure via one or more pressure sensors 214 that are configured, for example in conjunction with the resolver 210-1 of FIG. 2 or the choke/check valve 210-2 of FIG. 3, to detect the combination of both the standby pressure provided by the primary pump 120 and the margin pressure provided by the secondary pump 122.

Based on such pressure measurements and/or calculations, the controller 216 may be configured to, either by way of the margin pressure or by way of the cumulative pressure, determine if a predefined pressure threshold has been reached in step 300-6. More specifically, the pressure threshold may be a preprogrammed value which corresponds to the anticipated or detected load demand for a given steering input. If the detected margin pressure provided by the secondary pump 122 is sufficient to provide a cumulative pressure which substantially meets the given load demand or the corresponding pressure threshold, the controller 216 may be configured to disengage the secondary pump 122 and designate a successful health check in step 300-7 irrespective of the time remaining in the test duration. If, however, the cumulative pressure for a given iteration is sufficiently less than the predefined pressure threshold by more than an allowed deviation, the controller 216 may proceed to step 300-8 to determine whether the test duration has expired.

If the predefined test duration has not yet expired and time remains in the health check routine, the controller 216 may be configured to return to steps 300-5 and 300-6 and continue monitoring the cumulative pressure in relation to the pressure threshold. Moreover, the controller 216 may repeat such cycle either until the cumulative pressure substantially reaches the predefined threshold, or until the test duration expires, whichever event occurs first. If the cumulative pressure substantially reaches the predefined threshold before the test duration expires, the controller 216 may disengage the secondary pump 122 and designate a successful health check, as described in accordance with step 300-7 above. If the test duration expires before the cumulative pressure reaches the pressure threshold, the controller 216 may disengage the secondary pump 122 and designate the health check as unsuccessful in step 300-9. In further modifications, the controller 216 may additionally signal, alert or otherwise provide indications corresponding to passed and/or failed health check results to an operator of the associated work machine 100.

Correspondingly, according to the method 400 of FIG. 6, the controller 216 in step 400-1 may similarly standby for a startup condition to trigger a health check routine to be performed on the emergency steering pump system 200 of FIG. 4. Once a startup condition or an otherwise sufficient triggering event is detected, the controller 216 in step 400-2 may check to ensure that all machine parameters satisfy prerequisite conditions prior to proceeding with the health check or operational readiness test. For example, the controller 216 may be configured to determine whether the associated power source or engine 102 is operating, and whether the relevant hydraulic valves 124 of the steering system 106 are enabled or closed, or the like. If the power source or engine 102 is determined to be off, or if all relevant steering valves 124 are not yet closed, the controller 216 may return to step 400-1 and remain in standby until all prerequisite conditions are satisfied. The controller 216 may also detect for other machine parameters during step 400-2 which may be necessary for optimum testing, and/or the controller 216 may be configured to perform step 400-2 in conjunction with the standby step of 400-1.

If all prerequisite conditions are satisfied in step 400-2, for example, if the engine 102 is confirmed to be operating and the steering valves 124 are confirmed to be closed, the controller 216 may proceed to determine or monitor the standby pressure provided by the primary pump 120 in step 400-3. The controller 216 may observe the standby pressure via any one or more pressure sensors 214 that are dedicated to or otherwise associated with the primary pump 120. In step 400-4, the controller 216 may be configured to activate the 2-position, 3-way solenoid 210-3, or the like, so as to communicate the primary standby pressure to the emergency load sense, and engage the secondary pump 122 for a predefined test duration similar to step 300-4 of method 300 in FIG. 5. Once the secondary pump 122 is operating, the controller 216 may monitor the margin pressure provided by the secondary pump 122 in step 400-5, for instance, by monitoring the cumulative pressure provided by the emergency steering pump system 200. Specifically, the controller 216 may be configured to obtain the cumulative pressure via one or more pressure sensors 214 that are arranged to detect the combination of both the standby pressure provided by the primary pump 120 and the margin pressure provided by the secondary pump 122.

Based on such pressure measurements and/or calculations, the controller 216 may be configured to, by way of the margin pressure or by way of the cumulative pressure, determine if a predefined pressure threshold has been reached in step 400-6. More specifically, the pressure threshold may be a preprogrammed value which corresponds to the anticipated or detected load demand for a given steering input. If the detected margin pressure provided by the secondary pump 122 is sufficient to provide a cumulative pressure which substantially meets the given load demand or the corresponding pressure threshold, the controller 216 may be configured to disengage the secondary pump 122, and designate a successful health check in step 400-7 irrespective of the time remaining in the test duration. For example, the controller 216 may deactivate or open an on/off solenoid in the secondary pump load sense line to disengage the secondary pump. If, however, the cumulative pressure for a given iteration is sufficiently less than the predefined pressure threshold by more than an allowed deviation, the controller 216 may proceed to step 400-8 to determine whether the test duration has expired.

If the predefined test duration has not yet expired and time remains in the health check routine, the controller 216 may be configured to return to steps 400-5 and 400-6 and continue monitoring the cumulative pressure in relation to the pressure threshold. Moreover, the controller 216 may repeat such cycle either until the cumulative pressure substantially reaches the predefined threshold, or until the test duration expires, whichever event occurs first. If the cumulative pressure substantially reaches the predefined threshold before the test duration expires, the controller 216 may disengage the secondary pump 122, for example by deactivating or opening an on/off solenoid in the secondary pump load sense line, and designate a successful health check, as described in accordance with step 400-7 above. If the test duration expires before the cumulative pressure reaches the pressure threshold, the controller 216 may disengage the secondary pump 122, such as by deactivating or opening an on/off solenoid in the secondary pump load sense line, and designate the health check as unsuccessful in step 400-9.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of determining readiness of an emergency steering pump system, the method comprising:
detecting a startup condition;
determining a standby pressure provided by a primary pump and a margin pressure to be provided by a secondary pump;
engaging the secondary pump for a predefined duration based on the standby pressure and the margin pressure; and
determining readiness based on a cumulative pressure of the standby pressure and the margin pressure as compared to a predefined threshold corresponding to load demand.

2. The method of claim 1, further comprising ensuring an associated engine is operating and associated steering valves are closed once a startup condition is detected.

3. The method of claim 1, further comprising designating the readiness of the emergency steering pump system as successful if the cumulative pressure substantially reaches the predefined threshold prior to the expiration of the predefined duration.

4. The method of claim 1, further comprising designating the readiness of the emergency steering pump system as unsuccessful if the cumulative pressure is less than the predefined threshold upon expiration of the predefined duration.

5. The method of claim 1, further comprising disengaging the secondary pump upon one of:
the predefined duration expiring, and
the cumulative pressure substantially reaching the predefined threshold.

6. The method of claim 1, wherein the secondary pump is engaged by operating an electric motor coupled thereto and an unloader valve configured to selectively adjust the margin pressure according to a pressure differential between the load demand and the standby pressure.

7. The method of claim 1, wherein the standby pressure and the margin pressure are accumulated using a pressure control mechanism disposed in communication with at least one of the primary pump and the secondary pump, the pressure control mechanism including one of a resolver, a choke/check valve, and a solenoid.

8. The method of claim 1, wherein a 2-position, 3-way solenoid is used to communicate the standby pressure to an emergency load sense, and engage the secondary pump for the predefined duration.

9. An emergency steering pump system for a primary pump providing a standby pressure, the emergency steering pump system comprising:
a secondary pump for providing a margin pressure;
a pressure control mechanism in communication with at least one of the primary pump and the secondary pump, the resolver being configured to accumulate the margin pressure based at least partially on load demand; and
a controller in communication with each of the primary pump and the secondary pump, the controller, upon startup, being configured to engage the secondary pump for a predefined duration, monitor a cumulative pressure of the standby pressure and the margin pressure, and determine readiness of the secondary pump based on the cumulative pressure as compared to a predefined threshold corresponding to the load demand.

10. The emergency steering pump system of claim 9, being implemented in a work machine having at least one engine and one or more steering valves in communication with the emergency steering pump system, the controller being configured to ensure that the engine is operating and that the steering valves are closed upon startup of the work machine.

11. The emergency steering pump system of claim 9, wherein the controller is further configured to designate the readiness of the secondary pump as successful if the cumulative pressure substantially reaches the predefined threshold prior to the expiration of the predefined duration.

12. The emergency steering pump system of claim 9, wherein the controller is further configured to designate the readiness of the secondary pump as unsuccessful if the cumulative pressure is less than the predefined threshold upon the expiration of the predefined duration.

13. The emergency steering pump system of claim 9, wherein the controller is further configured to disengage the secondary pump upon one of:
the predefined duration expiring, and
the cumulative pressure substantially reaching the predefined threshold.

14. The emergency steering pump system of claim 9, wherein the secondary pump includes an electric motor and an unloader valve, the controller being configured to engage the secondary pump via operation of the electric motor, the unloader valve being configured to selectively adjust the margin pressure provided by the secondary pump based on communications from the pressure control mechanism.

15. The emergency steering pump system of claim 9, wherein the pressure control mechanism includes one of a resolver, a choke/check valve, and a 2-position, 3-way solenoid which communicates a load sense signal to an unloader valve of the secondary pump, the load sense signal being indicative of at least the load demand.

16. The emergency steering pump system of claim 9, further comprising at least one pressure sensor configured to detect the cumulative pressure of the standby pressure and the margin pressure, and communicate the cumulative pressure to the controller.

17. An emergency steering pump system for a primary pump providing a standby pressure upon startup, the emergency steering pump system comprising:
a secondary pump for providing a margin pressure; and
a resolver in communication with each of the primary pump and the secondary pump, the resolver being configured to accumulate the margin pressure provided by the secondary pump such that a sum of the standby pressure and the margin pressure substantially approximates load demand.

18. The emergency steering pump system of claim 17, wherein the secondary pump includes an electric motor and an unloader valve, the electric motor being configured to operate the secondary pump for a predefined duration upon startup, the unloader valve being configured to selectively adjust the margin pressure provided by the secondary pump based on communications from the resolver.

19. The emergency steering pump system of claim 17, wherein the resolver communicates a load sense signal to an unloader valve of the secondary pump, the load sense signal being indicative of at least a pressure differential between the load demand and the standby pressure provided by the primary pump.

20. The emergency steering pump system of claim 17, further comprising at least one pressure sensor configured to measure the sum of the standby pressure and the margin pressure, and communicate the measurement to an associated controller.
